(19) United States
(12) Patent Application Publication
(10) Pub. No.: US 2024/0359192 A1
(43) Pub. Date: Oct. 31, 2024

(54) AUTOMATED EXTRACTION OF A SUBSTANCE FROM A TUBE

(71) Applicant: JAGUAR GENE THERAPY, LLC, Lake Forest, IL (US)

(72) Inventors: Andrew Knudten, Lake Forest, IL (US); Phillip Wagner, Lake Forest, IL (US); Benjamin Kremkow, Lake Forest, IL (US)

(21) Appl. No.: 18/681,815

(22) PCT Filed: Aug. 8, 2022
(86) PCT No.: PCT/US22/39728

§ 371 Date: Feb. 6, 2024

Related U.S. Application Data
(60) Provisional application No. 63/230,459, filed on Aug. 6, 2021.

(51) Int. Cl. B04B 15/06; B04B 15/08; G01N 35/00; G01N 35/04

(52) U.S. Cl. CPC B04B 15/06; B04B 15/08; G01N 35/0099; G01N 35/04; G01N 2035/0449

(57) ABSTRACT

Technologies are provided for automated extraction of a substance from a tube. The technologies comprise a system that includes an aseptic extraction chamber and a transfer arm configured to position an ultracentrifuge (UC) tube within the aseptic extraction chamber. The UC tube contains a liquid solution that has particulate matter embedded therein, where the particulate matter forms multiple layers. The system also includes an extractor arm configured to extract a particular layer of the multiple layers.

### CROSS-REFERENCE TO RELATED APPLICATION

This application claims the benefit of and priority to U.S. Provisional Patent Application No. 63/230,459, filed Aug. 6, 2021, the contents of which application are hereby incorporated herein by reference in their entireties.

### SUMMARY

It is to be understood that both the following general description and the following detailed description are illustrative and explanatory only and are not restrictive.

In one embodiment, the disclosure provides a system. The system includes an aseptic extraction chamber; a transfer arm configured to position an ultracentrifuge (UC) tube within the aseptic extraction chamber, the UC tube containing a liquid solution that has particulate matter embedded therein, wherein the particulate matter forms multiple layers; and an extractor arm configured to extract a particular layer of the multiple layers.

In another embodiment, the disclosure provides an apparatus. The apparatus includes at least one processor that executes computer-executable components stored in at least one memory device. The computer-executable components include an imaging module configured to generate location data defining a position of a UC tube within an aseptic extraction chamber, and further defining respective positions of multiple layers of particulate matter within the UC tube. The computer-executable components also include an extraction module configured to direct, based on the location data, an extractor arm to move to a position within the aseptic extraction chamber for extraction of a particular layer of the multiple layers, and direct an extractor unit integrated into the extractor arm to fill a collection receptacle coupled to the extractor arm.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout. The drawings are not drawn to scale.

FIG. 1 illustrates an example of a system for automated extraction of a substance from a tube, in accordance with one or more embodiments of this disclosure.

FIG. 2 illustrates an example of an apparatus to control the automated extraction of a substance from a tube, in accordance with one or more embodiments of this disclosure.

FIG. 3 illustrates an example of a method for automatically extracting a substance from a tube, in accordance with one or more embodiments of this disclosure.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

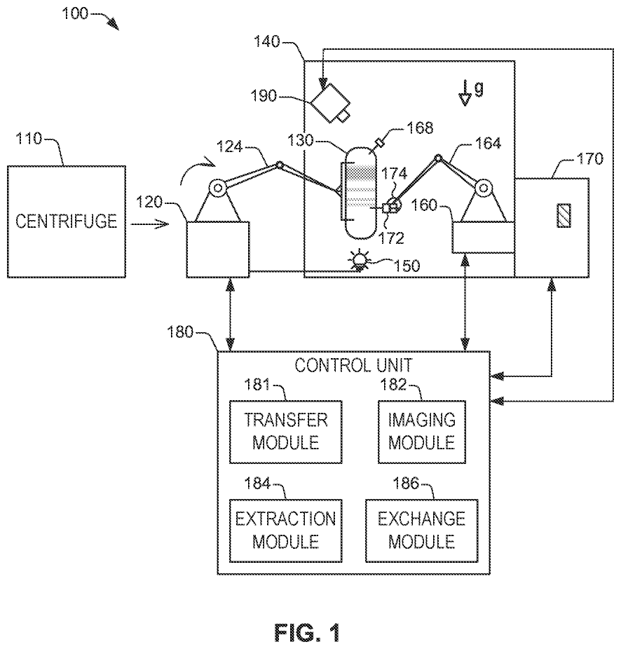

FIG. 1 illustrates an example of a system 100 in accordance with one or more embodiments of this disclosure. The system 100 can include a centrifuge chamber 110 that permits centrifugation of one or multiple ultracentrifuge (UC) tubes containing a liquid solution that has particulate matter embedded therein. The particulate matter is the solute in the liquid solution and one of various solvents can be used in the liquid solution. The particulate matter can include particles of different sizes. In some liquid solutions, the particulate matter also can include different particle densities. In some cases, the liquid solution can be embodied in a viral vector solution (using cesium chloride or iodixanol as a solvent, for example). Each UC tube of the one or multiple UC tubes can be loaded with the liquid solution from bottom end to a top end to minimize bubble formation within the UC tube. Here, “top” and “bottom” are defined relative to the orientation of the force vector of gravity, with the direction from top to bottom being the same as the direction of that force vector. After the UC tube is full or otherwise loaded up to a desired level, the UC tube is sealed. The one or multiple UC tubes can be balanced within the centrifuge chamber 110 to mechanically stabilize the centrifugation process. The centrifugation process can create multiple bands of particulate matter of respective types according to a formed density gradient along a longitudinal axis of a UC tube, where each one of the multiples bands is suspended within the solvent present in the liquid solution. A band of particulate matter refers to a layer of particulate matter, where the layer extends primarily along a direction that is perpendicular to the longitudinal axis of the UC tube. The layer has a thickness that can be substantially uniform.

The system 100 also can include a transfer assembly 120 that includes a transfer arm 124 that can remove a UC tube 130 from the centrifuge chamber 110 after centrifugation. The transfer arm 124 can remove the UC tube 130 without causing disturbance to the multiple bands. The transfer arm 124 can be a robotic arm that can be controlled by a computing apparatus, such as a control unit. The transfer arm 124 can position the removed UC tube 130 in an aseptic extraction chamber 140 and can serve as a secure holder.

It is noted that the disclosure is not limited to relying on the transfer arm 124 to move the UC tub 130 from the centrifuge chamber 110 to the aseptic extraction chamber 140. Indeed, in some example scenarios, placement of the UC tube 130 within the aseptic extraction chamber 140 can be accomplished without utilizing the transfer arm 124. Accordingly, in some embodiments, other mechanisms besides such the transfer arm 124 can be used to place and, optionally, hold the UC tube 130 at a desired position within the aseptic extraction chamber 140.

A light source 150 (such as a lamp or solid-state lighting device) can be assembled within or nearby the aseptic extraction chamber 140 and can illuminate the UC tube 130 and the multiple bands contained in the UC tube 130. The light source 150 can emit light having wavelengths within a defined portion of the spectrum of electromagnetic radiation. The multiple bands are represented with grey blocks of different sizes in FIG. 1.

The system 100 can further include an extractor assembly 160 having an extractor arm 164 that can extract an amount of solute from the UC tube 130. Specifically, the extractor arm 164 can extract a particular band of the multiple bands present in the UC tube 130. As mentioned, the UC tube 130 is sealed. Accordingly, to remove the particular band, the extractor arm 164 can puncture the UC tube 130 at, or in a vicinity of, the top of the UC tube 130. In one configuration, the extractor arm 164 can have a needle removably attached at a distal end of the extractor arm 164. That needle can pierce the UC tube 130, creating an opening on the UC tube 130. Puncturing the UC tube 130 can create an opening that serves as a vent. In some cases, the extractor arm 164 can perform a twisting motion in order to puncture the sealed UC tube 130 while avoiding coring into the needle. Because a gas (air or an inert gas, for example) from the environment surrounding the UC tube 130 can enter the punctured UC tube 130, the extractor arm 164 can be positioned, relative to the UC tube 130, to have the tip bevel of the needle facing towards the top of the UC tube 130. In such an arrangement, the gas may not interfere with a top band (that is, band nearest to the vent) present in the UC tube 130. The extractor arm 124 can be a robotic arm that can be controlled by a computing apparatus, such as a control unit.

Further, after the UC tube 130 has been punctured, the extractor arm 164 can release the needle, thus providing a vent conduit 168. The extractor arm 164 can then be coupled to an exchanger unit 170. The coupling can permit removably attaching a receptacle 172 to the extractor arm 164. The receptacle 172 can have a needle attached to an end. The extractor arm 164 can puncture, by means of the needle, the UC tube 130 directly below a desired band for collection of an amount of solute into the receptacle 172. The extractor arm 164 can puncture the UC tube 130 without redistributing one or more bands within the solvent. In other words, the extractor arm 164 can preserve the arrangement (or profile) of bands present in the UC tube 130. The tip bevel of the needle can be oriented toward the top of the UC tube 130. In that fashion, the solute that form the desired band can be preferentially extracted.

After the UC tube 130 has been punctured with the needle attached to the receptacle 172, an extractor unit 174 integrated into the extractor arm 164 can fill the receptacle 172 with the solute that constitutes the desired band. The extractor unit 174 can be integrated at a distal end of the extractor arm 164, in proximity to the receptacle 172, in some cases. The extractor unit 174 can be coupled (e.g., fluidically coupled, mechanically coupled, and/or electrically coupled) to the receptacle 172. The extractor unit 174 and the receptacle 172 can form an extraction assembly. The extractor unit 174 can include a piston that hermetically closes the receptacle 172. The piston is depicted as partially contained within the receptacle 172. The extractor unit 174 can move the piston to create a space within the receptacle 172 and thereby suction an amount of solute from the liquid solution contained in the UC tube 130. The amount of solute can form a desired band of within the UC tube 130. As the piston is moved, gas from the environment surrounding the UC tube 130 can enter the UC tube 130 through the vent conduit 168. Thus, other bands within the UC tube 130 can remain unperturbed during the extraction of the desired band. The piston can be moved until the desired band has been essentially entirely removed from the UC tube 130, for example. Hence, extraction can end prior to extracting a next band.

During extraction of a band, the extractor arm 164 can maintain the position of the needle relative to the band being extracted. For example, the extractor arm 164 can maintain the needle on a plane that is essentially parallel to a plane that contains the band and is perpendicular to a longitudinal axis of the UC tube 130. As illustrated in FIG. 1, the longitudinal axis can be oriented along the direction of the force vector of gravity (represented by a short open-head arrow labeled with a boldface letter g in FIG. 1).

After the desired band has been extracted from the UC tube 130, the extractor arm 164 can move from an extraction position (as is illustrated in FIG. 1) to another position where the extractor arm 164 can be coupled to the exchanger unit 170 (or a member thereof). That other position can referred to as a release-and-store position, simply for the sake of nomenclature. The coupling between the extractor arm 164 and the exchanger unit 170 (or the member thereof) can permit releasing the filled receptacle 172 from the extractor arm 164. The filled receptacle 172 that has been released can be replaced in a slot from where the receptacle 172 was previously coupled to the extractor arm 164 prior to extraction of the desired band. The slot is represented by a hatched rectangle within the exchanger unit 170. In some embodiments, the filled receptacle 172 that has been released can be placed in a storage compartment within, or coupled to, the exchanger unit 170. The coupling between the extractor arm 164 and the exchanger unit 170 (or the member thereof) also can permit removably attaching a clean receptacle to the extractor arm 164. The attached clean receptacle also can have a needle attached to an end. The extractor arm 164 can then be used to extract another band from the UC tube 130, in accordance with aspects described herein.

The system 100 also includes a control unit 180 that controls movement of the transfer arm 124 and other operations of the transfer arm 124. To that end, the control unit 180 can include a transfer module 181 that can direct the transfer arm 124 to remove the UC tube 130 from the centrifuge 110. The transfer module 181 also can direct the transfer arm 124 to place the UC tube 130 in the aseptic extraction chamber 140, without disturbance of bands present in the UC tube 130. Such removal and placement operations constitute a transfer operation by which the UC tube 130 is transferred from the centrifuge 110 to the aseptic extraction chamber 140.

The control unit 180 also controls movement of the extractor arm 164 and other operations of the extractor arm 164. The control unit 180 can utilize imaging data defining images of the UC tube 130 and bands contained therein. A camera 190 can generate the imaging data. The imaging data can be generated in real-time, in some cases. Although a single camera 190 is illustrated in FIG. 1, the technologies described in this disclosure are not limited in that respect. Indeed, in some embodiments, multiple cameras can be included in the system 100.

The control unit 180 can use the imaging data to generate location data corresponding to the UC tube 130 and the bands present therein, relative to a defined system of coordinates. To that end, the control unit 180 can apply one or several machine-vision techniques to the imaging data to identify the UC tube 130 and the bands present therein. An imaging module 182 can apply those techniques, in some embodiments. Such identification permits the control unit 180 to generate the location data. The location data can include first data defining coordinates of a boundary of the UC tube 130 in the defined system of coordinates. The location data also can include second data defining coordinates of at least one of the bands.

In some embodiments, as is illustrated in FIG. 1, the control unit 180 can include an extraction module 184 that can direct the extractor arm 164 to be positioned according to the location data. The location data can be updated as the imaging data becomes available. Hence, the extraction module 184 can control the position of the extractor arm 164 as the location data is updated based on the imaging data. For instance, the imaging data can be available in real-time and, therefore, the extraction module 184 can control the position of the extractor arm 164 in real-time or nearly real-time. The extraction module 184 also can control the extractor unit 174 attached to the extractor arm 164 in order to fill the receptacle 172 after the extractor arm 164 has been placed in position for extraction of a desired band.

In some embodiments, the extraction module 184 can control the position and/or orientation of the camera 190 (and/or other cameras that may be present within the aseptic extraction chamber 140) relative to the UC tube 130. By adjusting the position and/or orientation of the camera 190 (or another camera present in the aseptic extraction chamber 140) the extraction module 184 can adjust camera vantage point of the camera 190 and, thus, can ensure that a desired band within the UC tube 130 is adequately viewed and the position of the desired band is determined with satisfactory accuracy. Simply for purposes of illustrations, a band is viewed adequately when occlusions are absent in the field of view.

In some cases, the imaging module 182 can cause the extraction module 184 to adjust the position and/or orientation of the camera 190 based on quality of location data generated by the imaging module 182. For instance, the imaging module 182 can determine a quality metric quantifying accuracy of a position of a desired band within the UC tube 130, where the position is determined using location data obtained in accordance with aspects described herein. When the quality metric is less than, or equal to, a defined threshold value, the imaging module 182 can direct the extraction module 184 to adjust the position of the camera 190.

The control unit 180 can include an exchange module 186 that can control the attachment of a collection receptacle (e.g., receptacle 172) to the extractor arm 164 and the release of the collection receptacle from the extractor arm 164. The exchange module 186 also can control the retention of a filled collection receptacle within a storage compartment that may be present within the exchanger unit 170.

The control unit 180 is functionally coupled to the transfer assembly 120, the extractor assembly 160, the exchanger unit 170, and the camera 190 by means of one or more bus architectures (represented with arrows in FIG. 1). As an illustration, a bus architecture can be embodied in a controller area network (CAN) bus, a Modbus, other types of fieldbus architectures, or similar architectures.

Although the control unit 180 is shown as a single component coupled to other components involved in the automated extraction of a desired band from the UC tube 130, the technologies described herein are not limited in that respect. Indeed, in some embodiments, the control unit 180 can be spatially distributed, where the modules that constitute the control unit 180 can be distributed across the components being controlled. In one example, the transfer module 181 can be deployed in the transfer assembly 120, the extraction module 184 can be deployed in the extractor assembly 160, and the exchange module 186 can be deployed in the exchanger unit 170, and the imaging module 182 can be deployed in the camera 190.

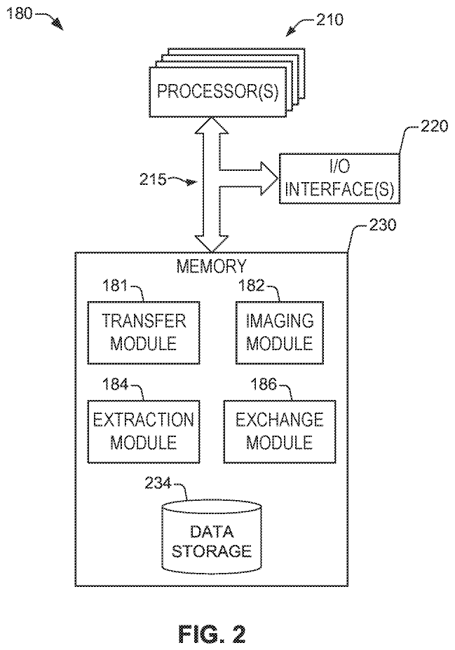

Each one or a combination of the transfer module 181, the imaging module 182, the extraction module 184, or the exchange module 186 can be embodied in hardware or a combination of hardware and software. In some embodiments, each one of those modules can be embodied in software retained, in processor-executable form, in one or multiple memory devices. More specifically, in such embodiments, as is illustrated in FIG. 2, the control unit 180 can include one or several processors 210 functionally coupled to one or multiple memory devices 230 (referred to as memory 230) and one or multiple input/output (I/O) interfaces 220. The processor(s) 210, individually or in combination, can execute such modules in order to perform the functionality described herein in connection with extraction of a solute band from a UC tube (e.g., UC tube 130). Each one of the processor(s) can include electronic circuitry that can operate on data and/or signaling. As an illustration, a processor can be embodied in programmable logic circuitry, a field-programmable gate array (FPGA), an application specific integrated circuit (ASIC), a digital signal processor (DSP), a programmable logic array (PLA), a hardware multi-thread microprocessor, a central processing unit (CPU), a graphical processing unit (GPU), a tensor processing unit (TPU), or a combination thereof. In some cases, each one of the processor(s) 210 can have at least one processing core, the processor(s) 210 can be assembled in one or multiple chipsets.

The processor(s) 210 can be functionally coupled to the memory 230 and, in some configurations, to one another, by means of one or several communication interfaces 215, for example. The communication interface(s) 215 can include one or many bus architectures, such as an Ethernet-based industrial bus, a CAN bus, a Modbus, other types of fieldbus architectures, a combination thereof, or the like. In addition, or in some cases, communication interface(s) 215 can include other types of bus architectures, including a memory bus or memory controller, a peripheral bus, an accelerated graphics port, or local bus, or similar. In some embodiments, the communication interface(s) 220 also can include wireless bus architectures.

The memory 230 comprises computer readable media in the form of volatile memory, such as random access memory (RAM), and/or non-volatile memory, such as read only memory (ROM). The memory 230 can store machine-accessible components (e.g., computer-readable components and/or computer-executable components). The machine-accessible components can embody, or can constitute, the transfer module 181, the imaging module 182, the extraction module 184, and the exchange module 186. Thus, machine-accessible instructions (e.g., computer-readable instructions and/or computer-executable instructions) embody or otherwise constitute each one of the machine-accessible components within the memory 230. The machine-accessible instructions can be encoded in the memory 230 and can be arranged to form each one of the machine-accessible components. The machine-accessible instructions can be built (e.g., linked and compiled) and retained in computer-executable form within the memory 230. The memory 230 also can include data storage 234 containing data that permits various of the functionalities described herein.

The machine-accessible components, individually or in a particular combination, can be accessed and executed by at least one of the processor(s) 210. In response to execution, each one of the machine-accessible components can provide the functionality described herein in connection with the transfer module 181, the imaging module 182, the extraction module 184, and the exchange module 186. Accordingly, execution of the machine-accessible components retained in the memory 230 can cause the transfer assembly 120 (and transfer arm 124), camera 190, extractor assembly 160 (and extractor arm 164) and the exchanger unit 170 to operate in accordance with aspects described herein.

The I/O interfaces 220 can include, for example, various types of connectors that permit coupling the control unit 180 to various types of equipment—e.g., the camera 190; the extractor assembly 120 and members thereof; the transfer assembly 160 and members thereof; and the exchanger unit 170 and members thereof, Such a coupling permits the control unit 180 to send data and/or signaling and to receive other data and/or other signaling. For example, control unit 180 can send directives or other types of instructions that control the operation of equipment functionally coupled to the control unit 180 via such connectors. The I/O interfaces 220 also can include one or more human-machine interfaces (HMIs), in some cases.

The control unit 180 also can include other types of computing resources. In some embodiments, those resources can permit or otherwise facilitate the execution of the machine-accessible components retained in the memory 230 and the ensuing operation of the transfer arm 124 and the extractor arm 164. Those computing resources can include, for example, memory controller(s); incoming bandwidth and/or outgoing bandwidth; interface(s) (such as I/O interfaces); power supplies; and the like.

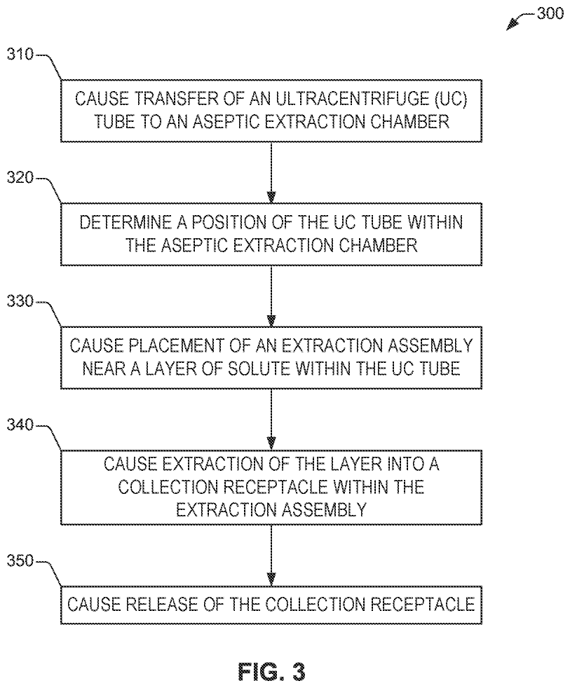

FIG. 3 illustrates an example method 300 for automatically extracting a substance from a UC tube, in accordance with one or more embodiments of this disclosure. The example method 300 can constitute a control sequence for the automated extraction of the substance from the UC tube. The substance can be particular matter in liquid solution with a solvent. The UC tube (e.g., UC tube 130) can contain the liquid solution. In one example, the liquid solution can be a viral vector solution and the solvent can be one of cesium chloride or iodixanol.

A computing apparatus or a system of computing apparatuses can implement the example method 300 partially or in its entirety. A computing apparatus refers to an apparatus that includes electronic circuitry that can operate on data and/or signaling. The computing apparatus that implements the example method 300 can embody the control unit 180. As such, the computing apparatus can host the transfer module 181, the imaging module 182, the extraction module 184, and the exchange module 186. Accordingly, in some embodiments, the computing apparatus can perform one or more of the blocks (individually or in combination) of the example method 300 in response to execution of the transfer module 181, the imaging module 182, the extraction module 184, or the exchange module 186, or a combination thereof.

At block 310, the computing apparatus can cause transfer of the UC tube to an aseptic extraction chamber (e.g., aseptic extraction chamber 140 (FIG. 1)). Prior to the transfer, the UC tube can be subjected to centrifugation and, as a result, the multiple layers (or bands) of particular matter can be formed within the liquid solution. The computing apparatus can cause the transfer by directing, via the transfer module 181, a robotic arm to remove the UC tube a centrifuge and to place the UC tube into the aseptic extraction chamber. The robotic arm can be transfer arm 124 (FIG. 1), for example.

In some embodiments of the example method 300, other mechanisms besides such a robotic arm may be relied upon to achieve placement of the UC tube within the aseptic extraction chamber. Indeed, in some cases, placement of the UC tube within the aseptic extraction chamber can be accomplished without utilizing the robotic arm.

At block 320, the computing apparatus can determine a position of the UC tube within the aseptic extraction chamber, relative to a defined system of coordinates. The position can be determined via the imaging module 182. To that end, the computing apparatus, via the imaging module 182, can generate location data defining the position of the UC tube within the aseptic extraction chamber. The location data also can define respective positions of the multiple layers of particulate matter within the UC tube. Accordingly, the location data can include first data defining coordinates of a boundary of the UC tube, in the defined system of coordinates. Additionally, the location data also can include second data defining coordinates of at least one of the multiple layers, in the defined system of coordinates. The computing apparatus, via the imaging module 182, can generate the location data using imaging data from a camera (e.g., camera 190 (FIG. 1) within the aseptic extraction chamber. The imaging data define an image of the UC tube and the multiple layers.

At block 330, the computing apparatus can cause placement of an extraction assembly near a particular layer of solute within the UC tube. To that end, the computing apparatus can direct, based on the location data, a second robotic arm (e.g., the extractor arm 164 (FIG. 1)) to move to a position within the aseptic extraction chamber for extraction of the particular layer. Prior to directing the second robotic arm to move to that position, the computing apparatus can control, via the exchange module 186, attachment of a collection receptacle to the second robotic arm. More specifically, the computing apparatus can direct, using coordinates of the particular layer, the second robotic arm to place an extraction assembly in proximity to the particular layer. The extraction assembly includes a needle (or another type of piercing member), and thus, the computing apparatus also can direct the second robotic arm to further move the extraction assembly towards the boundary of the UC tube such that the needle (or the other type of piercing member) pierces the UC tube.

At block 340, the computing apparatus can cause extraction of the particular layer into a collection receptacle (e.g., receptacle 172 (FIG. 1)) within the extraction assembly. To that end, the computing apparatus, via the extraction module 184, can direct an extractor unit (e.g., extractor unit 174 (FIG. 1)) to fill the collection receptacle coupled to the second robotic arm. The extractor unit can be integrated into the second robotic arm, as part of the extraction assembly.

At block 350, the computing apparatus can cause release of the collection receptacle. To that end, the computing apparatus can direct, via the exchange module 186, the second robotic arm release of the collection receptacle.

While the methods, apparatuses, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
an aseptic extraction chamber;
a transfer arm configured to position an ultracentrifuge tube within the aseptic extraction chamber, the UC tube containing a liquid solution that has particulate matter embedded therein, wherein the particulate matter forms multiple layers; and
an extractor arm configured to extract a particular layer of the multiple layers.

2. The system of claim 1, further comprising a control unit configured to operate the extractor arm during extraction of the particular layer.

3. The system of claim 1, wherein the transfer arm is further configured to remove the UC tube from a centrifuge chamber prior to position the UC tube within the aseptic extraction chamber, wherein positioning the UC tube within the aseptic extraction chamber preserves an arrangement of the multiple layers within the UC tube.

4. The system of claim 1, wherein the UC tube is sealed and has a longitudinal axis oriented along the direction gravity, and wherein the particular layer has an essentially uniform thickness and is located at a section of the UC tube along the longitudinal axis.

5. The system of claim 4, wherein the extractor arm is removably coupled to a receptacle at a distal end of the extractor arm, the receptacle having a needle placed at an end of the receptacle.

6. The system of claim 4, wherein the extractor arm is further configured to puncture, using the needle, the UC tube at a position under the section.

7. The system of claim 6, wherein the extractor arm comprises an extractor unit that is configured to suction an amount of solute that forms the particular layer into the receptacle, resulting in the receptacle being filled with the amount of solute.

8. The system of claim 7, wherein the extractor arm is further configured to release the filled receptacle into a storage compartment of an exchanger unit.

9. The system of claim 1, wherein the liquid solution is a viral vector solution.

10. The system of claim 9, wherein the viral vector solution comprises a solvent including one of cesium chloride or iodixanol.

11. An apparatus comprising:
at least one processor that executes computer-executable components stored in at least one memory device, the computer-executable components comprising,
an imaging module configured to generate location data defining a position of an ultracentrifuge (UC) tube within an aseptic extraction chamber, and further defining respective positions of multiple layers of particulate matter within the UC tube; and
an extraction module configured to,
direct, based on the location data, an extractor arm to move to a position within the aseptic extraction chamber for extraction of a particular layer of the multiple layers, and
direct an extractor unit integrated into the extractor arm to fill a collection receptacle coupled to the extractor arm.

12. The apparatus of claim 11, wherein the imaging module is further configured to generate the location data using imaging data from a camera within the aseptic extraction chamber, the imaging data defining an image of the UC tube and the multiple layers.

13. The apparatus of claim 12, wherein generating the location data comprises applying one or more machine-vision techniques to the imaging data to identify the UC tube and the multiple layers.

14. The apparatus of claim 11, wherein the location data comprises first data defining coordinates of a boundary of the UC tube in a defined system of coordinates, and further comprises second data defining coordinates of at least one of the multiple layers.

15. The apparatus of claim 12, wherein the extraction module is further configured to adjust, based on the location data, one or more of position or orientation of the camera.

16. The apparatus of claim 11, wherein the computer-executable components further comprise an exchange module configured to control attachment of the collection receptacle to the extractor arm.

17. The apparatus of claim 16, wherein the exchange module is further configured to control release of the collection receptacle from the extractor arm.

18. The apparatus of claim 17, wherein the exchange module is further configured to control retention of a filled collection receptacle within a storage compartment within an exchanger unit.

19. The apparatus of claim 11, wherein the UC tube contains the particular matter in a liquid solution.

20. The apparatus of claim 19, wherein the liquid solution is a viral vector solution comprising a solvent that includes one of cesium chloride or iodixanol.

21. A system comprising:
an aseptic extraction chamber;
an ultracentrifuge tube within the aseptic extraction chamber, the UC tube containing a liquid solution that has particulate matter embedded therein, wherein the particulate matter forms multiple layers; and
an extractor arm configured to extract a particular layer of the multiple layers.
